(19) United States
(12) Patent Application Publication
(10) Pub. No.: US 2018/0077916 A1
(43) Pub. Date: Mar. 22, 2018

(54) ANTI-SPIDER LIGHTING DEVICE

(71) Applicants: Wilfred Joseph White, Reedsport, OR (US); Stephanie Stieler, Reedsport, OR (US)

(72) Inventors: Wilfred Joseph White, Reedsport, OR (US); Stephanie Stieler, Reedsport, OR (US)

(21) Appl. No.: 15/701,446

(22) Filed: Sep. 12, 2017

Related U.S. Application Data
(60) Provisional application No. 62/396,034, filed on Sep. 16, 2016.

(51) Int. Cl. A01M 1/04

(52) U.S. Cl. CPC A01M 1/04; A01M 29/10

(57) ABSTRACT

An anti-spider lighting device is a spider repelling device composed of at least one conductor wire having a plurality of spaced LED lights that emit a red light of a wavelength in the range between 620 to 630 nanometers which has been tested and proven to cause spiders to first be attracted, but then to flee from the lights. The lights are attached to various places beneath a bed frame and legs of the bed to prevent them from crawling into the bed covers.

### CROSS-REFERENCE TO RELATED APPLICATION

The present application is related to and claims priority from prior provisional application Ser. No. 62/396,034, filed Sep. 16, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of insect repellants and more specifically relates to an anti-spider lighting device.

### 2. Description of the Related Art

Perhaps one of the most feared creatures is the spider. Not only do they generate extreme discomfort at the thought of these eight-legged pests crawling onto a person, but the spider's natural defense mechanism, biting, inspires terror in most people. Thus, it stands to reason that the possibility of a spider infestation in the home is something most people dread the thought of. In general, spiders can be found in dark, secluded areas, both in the home and garden. While the site of a web is the most familiar indication of the presence of a spider, some spider species live in burrows rather than webs, and others are free-ranging and take refuge in crevices. The junction of a wall and ceiling, closets, and storage boxes are some of the most common areas spiders seek refuge. However, the darkened environments found underneath furniture, particularly sofas and beds, are also favorite hidey-holes for these arachnids.

A truly scary thought is imagining spiders lurking under beds or furniture; a thought that one will have frequently for a long time after a person really does find one in the covers of a bed or crawling off of the furniture onto the person. Many people have had their lives changed forever by poisonous spider bites. Necrosis of the skin and organ or nerve damage is common reported symptoms of spider bites. Spiders also have the ability to bite multiple times in one incident as if it wasn't bad enough already. Surgery is sometimes needed for Recluse bites. Unfortunately, spiders hiding in human habitation areas is a very common occurrence and results in countless bites every year. To rid a home of these pests, consumers have little choice but to rely on the costly services of an exterminator who more often than not will require a contract for an extended period of time. A solution is needed.

Various attempts have been made to solve the above-mentioned problems such as those found in U.S. Pat. No. 6,996,029 to Venus Boyd; U.S. Pat. No. D528184to Se Kit Yuen; and U.S. Publication No. 2009/0025275 to Lee William Cohnstaedt. None of the above inventions and patents, taken either singly or in combination, is seen to describe the invention as claimed.

Ideally, an insect repellant should repel insects without chemical odors, and yet, would operate reliably and be manufactured at a modest expense. Thus, a need exists for a reliable anti-spider lighting device to avoid the above-mentioned problems.

### BRIEF SUMMARY OF THE INVENTION

In view of the foregoing disadvantages inherent in the known insect repellants art, the present invention provides a novel anti-spider lighting device. The general purpose of the present invention, which will be described subsequently in greater detail, is to repel insects without chemical odors.

An anti-spider lighting device for repelling spiders may comprise a plurality of light members formed as light emitting diodes adapted to project light in wavelengths in the range between 620 to 630 nanometers, and at least one electric wire. The electric wire electrically connects the plurality of light members in a series circuit and connects the light members to form an elongated string of light members. A control member connected to the electric wire is adapted to control the flow of electricity to the plurality of light members. A power source is electrically connected to the at least one electric wire and adapted to provide electricity to the light members.

A plurality of connector members is adapted to connect the elongated string of light members to a chosen structure. The connector members may be formed as double-sided tape members. The elongated string of light members may include 60 spaced light members and may extend a length of 5 meters but the number of spaced light members and the length may vary. The elongated string of light members is preferably waterproof. The power source may provide 120 volts of alternating current but may also provide direct current in some embodiments. A transformer may be electrically connected between the power source and the electric wire and is adapted to convert power from the power source from 120 volts of alternating current into 12 volts of direct current.

The combination of a bed frame and an anti-spider lighting device may comprise a bed frame including a head board, a foot board, and two side boards. The two side boards are spaced from one another and connected between the head board and the foot board, and an anti-spider lighting device for repelling spiders comprising a plurality of light members formed as light emitting diodes adapted to project light of wavelengths in the range between 620 to 630 nanometers, and at least one electric wire electrically connected to the plurality of light members in a series circuit, and the electric wire electrically connects the plurality of light members to form an elongated string of the plurality of light members.

The anti-spider device is releasably connected to surfaces on the head board, the foot board, and the side boards to repel spiders therefrom. A control member connected to the electric wire(s) is adapted to control the flow of electricity to the light members. A power source is electrically connected to the electric wire and adapted to provide electricity to the light members. A plurality of connector members is adapted to connect to the elongated string of light members for attaching to a chosen structure. The plurality of connector members are formed as double-sided tape members. The elongated string of light members may include 60 spaced light members and may extend a length of 5 meters. The elongated string of light members is preferably waterproof and the power source provides 120 volts of alternating current. A transformer is electrically connected between the power source and the electric wire and is adapted to convert power from the power source from 120 volts of alternating current into 12 volts of direct current.

The present invention holds significant improvements and serves as an anti-spider lighting device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, anti-spider lighting device constructed and operative according to the teachings of the present invention.

FIG. 1 shows a perspective view illustrating an anti-spider lighting device according to an embodiment of the present invention.

FIG. 2 is a diagram illustrating an anti-spider lighting device according to an embodiment of the present invention of FIG. 1.

FIG. 3 is a perspective view illustrating a combination of a bed frame and an anti-spider lighting device according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to insect repellants and more particularly to an anti-spider lighting device as used to repel insects without chemical odors.

Generally speaking, an anti-spider lighting device is a spider repelling device composed of at least one conductor wire having a plurality of spaced LED lights that emit a red light of a wavelength in the range between 620 to 630 nanometers which has been tested and proven to cause spiders to first be attracted, but then to flee from the lights. The lights are attached to various places beneath a bed frame and legs of the bed to prevent them from crawling into the bed covers.

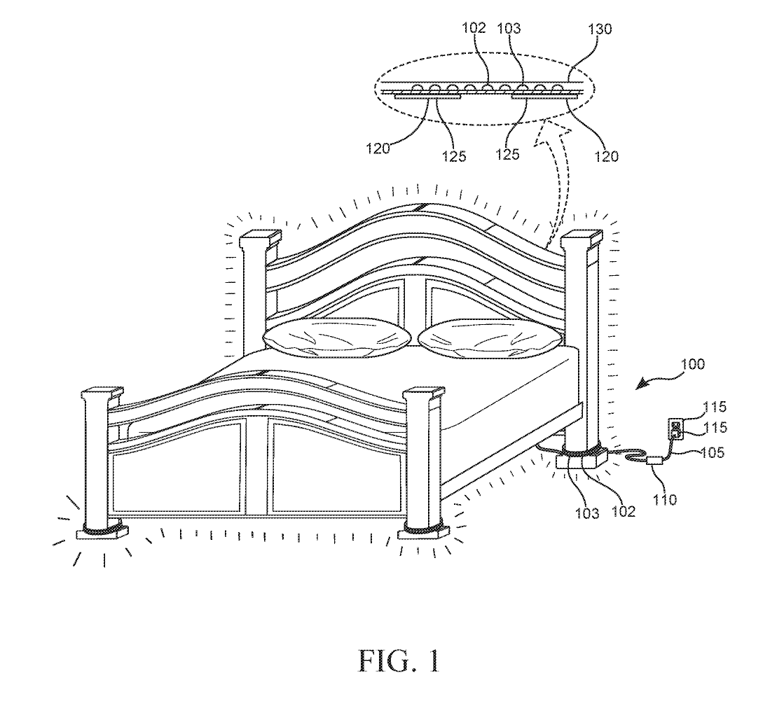

Referring to the drawings by numerals of reference there is shown in FIG. 1, a perspective view illustrating anti-spider lighting device 100 according to an embodiment of the present invention.

Anti-spider lighting device 100 for repelling spiders may comprise a plurality of light members 103 formed as light emitting diodes 102 adapted to project light in wavelengths in the range between 620 to 630 nanometers, and at least one electric wire 105. Electric wire 105 electrically connects the plurality of light members 103 in a series circuit and connects light members 103 to form elongated string of light members 130. Control member 110 connected to electric wire 105 is adapted to control the flow of electricity to the plurality of light members 103. Power source 115 is electrically connected to the at least one electric wire 105 and adapted to provide electricity to light members 103. A plurality of connector members 120 is adapted to connect elongated string of light members 130 to a chosen structure.

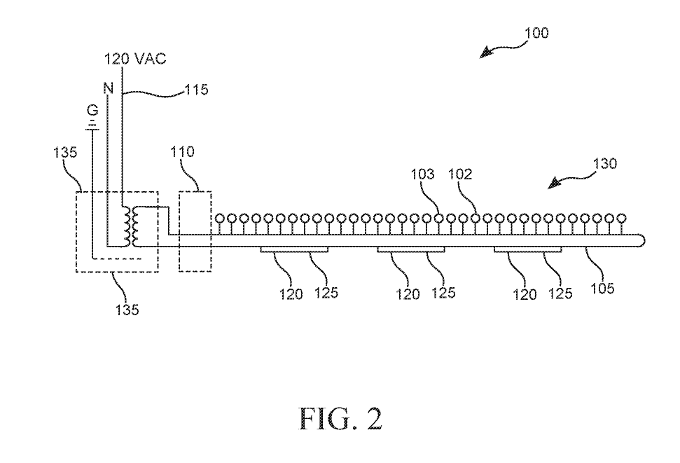

Referring now to FIG. 2, is a diagram illustrating an anti-spider lighting device according to an embodiment of the present invention of FIG. 1.

Connector members 120 may be formed as double-sided tape members 125. Elongated string of light members 130 may include 60 spaced light members 103 and may extend a length of 5 meters but the number of spaced light members 103 and the length may vary. Elongated string of light members 130 is preferably waterproof. Power source 115 may provide 120 volts of alternating current but may also provide direct current in some embodiments. Transformer 135 may be electrically connected between power source 115 and electric wire 105 and is adapted to convert power from power source 115 from 120 volts of alternating current into 12 volts of direct current.

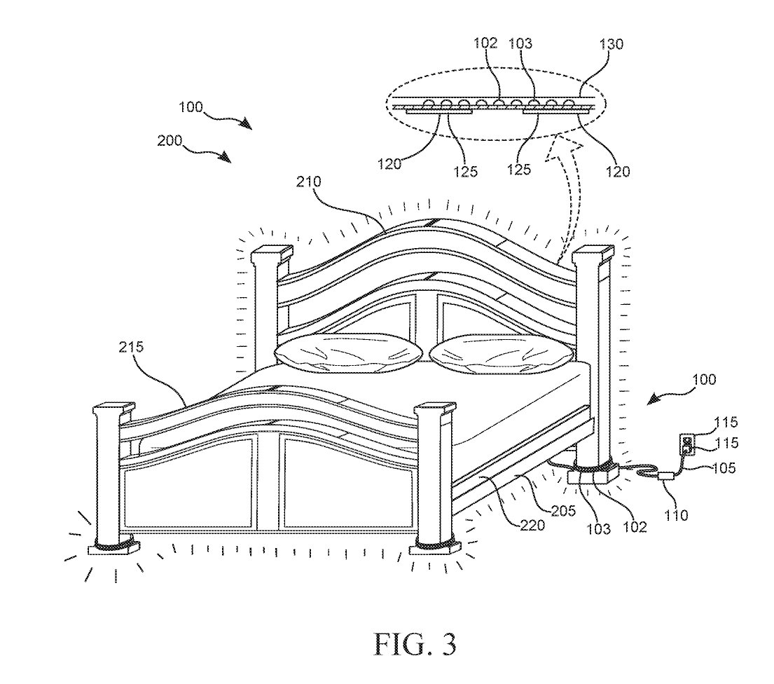

Referring now to FIG. 3, is a perspective view illustrating combination of a bed frame and an anti-spider lighting device 200 according to an embodiment of the present invention of FIG. 1.

Combination of a bed frame and an anti-spider lighting device 200 may comprise bed frame 205 including head board 210, foot board 215, and two side boards 220. The two side boards are spaced from one another and connected between head board 210 and foot board 215, and anti-spider lighting device 100 device for repelling spiders comprising a plurality of light members 103 formed as light emitting diodes 102 adapted to project light of wavelengths in the range between 620 to 630 nanometers, and at least one electric wire 105 electrically connected to the plurality of light members 103 in a series circuit, and electric wire 105 electrically connects the plurality of light members 103 to form elongated string of light members 130.

Anti-spider lighting device 100 is releasably connected to surfaces on head board 210, foot board 215, and side boards 220 to repel spiders therefrom. Control member 110 connected to electric wire 105 is adapted to control the flow of electricity to light members 103. Power source 115 is electrically connected to electric wire 105 and adapted to provide electricity to light members 103. A plurality of connector members 120 is adapted to connect to elongated string of light members 130 for attaching to a chosen structure. The plurality of connector members 120 are formed as double-sided tape members 125. Elongated string of light members 130 may include 60 spaced light members 103 and may extend a length of 5 meters. Elongated string of light members 130 is preferably waterproof and power source 115 provides 120 volts of alternating current. Transformer 135 is electrically connected between power source 115 and electric wire 105 and is adapted to convert power from power source 115 from 120 volts of alternating current into 12 volts of direct current.

Anti-spider lighting device 100 for bed frame 205 is a multi-channel low voltage, red light emitting diodes 102 string 130, powered by a 120 VAC to variable 9 VDC power supply that is attached to bed frame 205, underneath sofas, in corners and along baseboards of closets, and runs 24 hours a day, seven days a week. Baby beds and cribs can be used with anti-spider lighting device 100 to remove the risk and fear of having a child receiving a poisonous spider bite. The method of attaching elongated string of light members 130 can be the same regardless of the type of bed or object it is being attached to. Electrical wire attaching cradles used with wire zip-ties can be used in nearly any installation, but it should be noted that other attachment methods may be used as well when zip ties with adhesive cradles are not practical, such as when placing elongated string of light members 130 within channels or other similar installations. In addition, while anti-spider lighting device 100 is developed primarily for home use, it is not limited to that that use only. The system may be used in storage sheds and there may be multiple practical applications for industrial use such as in dark corners and areas of industrial plants where spiders tend to collect and become a hazard for maintenance employees.

Anti-spider lighting device 100 emits intense Red 620-630 nm light that temporary blinds the spiders that are at first drawn to this light. The effect of this blinding light may cause these spiders to recoil in fear after encountering it. This in conjunction with elongated string of light members 130 is the essence of the invention and may be manufactured new in combination with bed frame 205, head board 210, foot board 215, and/or side boards 220.

One of the side benefits of anti-spider lighting device 100 is it use as a night light. Children as well as some adults live in fear of what is crawling around under their bed and sometimes with good reason! Anti-spider lighting device 100 not only discourages spiders from coming under bed frame 205 in the first place but it lights up the floor around bed frame 205 so when you need to get up in the middle of the night for whatever reason, you can see the floor before you put your feet down.

Light plays a crucial role in helping the body function normally and produce the right amount of the essential hormone melatonin. Many people suffer from depression in the winter months due to a lack of sunlight similar to the way processed food has interfered with the body's assimilation of essential nutrients. The introduction of artificial light into our daily environment has led to serious disruptions of the “light cycle,” which refers to the biological need for alternating periods of light and darkness. The lack of sleep, from which an estimated 70 percent of Americans suffer, can contribute significantly to our susceptibility to all manner of illness including weight gain. Blue wavelengths are beneficial during daylight hours because they boost attention, reaction times, and mood seems to be the most disruptive at night. The proliferation of electronics with screens, as well as energy-efficient lighting, is increasing our exposure to blue wavelengths, especially after sundown. And though it might seem counter-intuitive, the color that keeps us awake is blue, while the ones more conducive to sleep are at the red end of the spectrum.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An anti-spider lighting device for repelling spiders, comprising:
a plurality of light members;
wherein said plurality of light members are formed as light emitting diodes adapted to project light in the wavelengths in the range between 620 to 630 nanometers; and
at least one electric wire;
wherein said at least one electric wire electrically connects said plurality of light members in a series circuit; and
wherein said at least one electric wire electrically connects said plurality of light members to form an elongated string of said plurality of light members.

2. The anti-spider lighting device of claim 1, further comprising a control member connected to said at least one electric wire and is adapted to control the flow of electricity to said plurality of light members.

3. The anti-spider lighting device of claim 1, further comprising a power source electrically connected to said at least one electric wire and adapted to provide electricity to said plurality of light members.

4. The anti-spider lighting device of claim 1, further comprising a plurality of connector members adapted to connect to said elongated string of said plurality of light members to a chosen structure.

5. The anti-spider lighting device of claim 4, wherein said plurality of connector members are formed as double-sided tape members.

6. The anti-spider lighting device of claim 1, wherein said elongated string of said plurality of light members includes 60 spaced light members and extends a length of 5 meters.

7. The anti-spider lighting device of claim 1, wherein said elongated string of said plurality of light members is waterproof.

8. The anti-spider lighting device of claim 3, wherein said power source provides 120 volts of alternating current.

9. The anti-spider lighting device of claim 8, further comprising a transformer electrically connected between said power source and said at least one electric wire and is adapted to convert power from said power source from 120 volts of alternating current into 12 volts of direct current.

10. A combination of a bed frame and an anti-spider lighting device, said combination comprising:
a bed frame including:
a head board;
a foot board;
and two side boards;
wherein said two side boards are spaced from one another and connected between said head board and said foot board; and
an anti-spider lighting device for repelling spiders, comprising:
a plurality of light members;
wherein said plurality of light members are formed as light emitting diodes adapted to project light in the wavelengths in the range between 620 to 630 nanometers; and
at least one electric wire;
wherein said at least one electric wire electrically connects said plurality of light members in a series circuit; and
wherein said at least one electric wire electrically connects said plurality of light members to form an elongated string of said plurality of light members.
wherein said anti-spider device is releasably connected to surfaces of said head board, said foot board, and said side boards to repel spiders therefrom.

11. The combination of claim 10, further comprising a control member connected to said at least one electric wire and is adapted to control the flow of electricity to said plurality of light members.

12. The combination of claim 10, further comprising a power source electrically connected to said at least one electric wire and adapted to provide electricity to said plurality of light members.

13. The combination of claim 10, further comprising a plurality of connector members adapted to connect to said elongated string of said plurality of light members to a chosen structure.

14. The combination of claim 13, wherein said plurality of connector members are formed as double-sided tape members.

15. The combination of claim 10, wherein said elongated string of said plurality of light members includes 60 spaced light members and extends a length of 5 meters.

16. The combination of claim 10, wherein said elongated string of said plurality of light members is waterproof.

17. The combination of claim 12, wherein said power source provides 120 volts of alternating current.

18. The combination of claim 17, further comprising a transformer electrically connected between said power source and said at least one electric wire and is adapted to convert power from said power source from 120 volts of alternating current into 12 volts of direct current.
